(19) United States
(12) Patent Application Publication
(10) Pub. No.: US 2007/0225197 A1
(43) Pub. Date: Sep. 27, 2007

(54) Method for Producing Granules and the Use Thereof in Washing and/or Cleaning Agents

(75) Inventors: Hans-Friedrich Kruse, Korschenbroich (DE); Bernhard Orlich, Barcelona (ES); Gerhard Blasey, Dusseldorf (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 11/547,575

(22) PCT Filed: Jan. 28, 2005
(86) PCT No.: PCT/EP05/00825

§ 371 Date: Nov. 20, 2006

(30) Foreign Application Priority Data
Apr. 3, 2004 (DE) 10-2004 016 497.5

(51) Int. Cl. C11D 11/00; B01F 13/10; B01J 2/16

(52) U.S. Cl. 510/444; 510/446

(57) ABSTRACT

Processes which comprise: (a) blending a solid component and a liquid component in a mixer/granulator to form an intermediate granule mix; and (b) further treating the intermediate granule mix in a fluidized bed granulator to form granules; wherein a first portion of the liquid component is introduced into the mixer/granulator and a second portion of the liquid component is introduced into the fluidized bed granulator are disclosed. The solubility of granules prepared in accordance with the disclosed processes can be manipulated. Detergent and/or cleansing agents containing such granules and tablets incorporating such agents, as well as their use, are also described.

This application relates to a method for the production of granules, in which one or a plurality of mixer/granulator(s) and fluid bed granulators are used and in which the liquid component is dispersed in a defined manner in the mixer/granulator(s) and fluid bed granulator.

In addition, the application relates to detergent tablets, preferably those comprising granules with delayed dissolution as well as the use of such detergent tablets in washing machines and automatic dishwashers.

Detergents and/or cleansing agents are available to the consumer in solid and in liquid form, the solid detergents and/or cleansing agents particularly being in turn offered in differently packaged forms, for example as powders or compactions (e.g. extrudates, tablets). The starting point for the production of these differently packaged forms is generally at least one detergent- and/or cleansing agent granule manufactured from detergent- and/or cleansing active raw materials, which can be blended with additional ingredients, for example to powders or compressed by the action of pressure to extrudates or tablets.

Granulation methods are extensively described in the prior art. Other than by conventional spray drying, granules can be manufactured by wet granulation, by dry granulation or compaction and by granulation of solidified melts. The commonest granulation technique is wet granulation as this technique is subject to the fewest limitations and is the most reliable for producing granules with favorable properties. Wet granulation is effected by moistening the powder mixture with solvents and/or mixtures of solvents and/or solutions of binders and/or solutions of adhesives and is preferably carried out in mixer/granulators, fluid beds or spray towers, wherein the cited mixer/granulators can be equipped, for example, with stirrers and kneading tools. However, combinations of fluid bed(s) and mixer(s)/granulators or combinations of various mixer/granulators can also be used for the granulation. Depending on the starting material and the desired product properties, the granulation is effected under the action of low to high shear forces.

The object of the invention consisted in the provision of a possibility of providing granules, in which a simple control of at least one product property is possible during the granulation.

Accordingly, the subject matter of the invention is a method for the production of granules, particularly detergent- and/or cleansing agent granules, by granulating solid and liquid components under the use of one or a plurality of mixers/granulators in a first process step with a downstream fluid bed granulator in a second process step, wherein an adjustment of the granule solubility is made by splitting up the liquid components between the mixer/granulator and fluid bed. Preferably, the particle size of the granule is also adjusted on splitting up the liquid component between the mixer/granulator and fluid bed. In the context of the present invention, the term “splitting up” also expressly includes the possibility that the liquid component to be split up is split up in such a way that 100 wt. % of the liquid component is apportioned to the mixer/granulator and 0 wt. % to the fluid bed. This extreme distribution is therefore also included in the term splitting up of the liquid component between the mixer/granulator and fluid bed.

The inventive granule can be preferably an ingredient of detergent- and/or cleansing agent formulations. The invention enables the production of granules of different properties and composition. Preferably, the differences can relate to the particle size composition and the solubility and thus to a delayed dissolution of the granule. The different granules of the invention can be mixed together into detergents and/or cleansing agents that in turn can show different properties that are preferably derived from those of the granules. Preferably, these finished products can even possess differently adjustable properties when they have the same composition in regard to the weight fractions of the individual ingredients, but differ in the granules being inventively manufactured.

Here, liquid components are also understood to mean those that are not liquid per se at room temperature, however are flowable at the relevant processing temperature, but particularly those that are already liquid at room temperature. In addition, the use of liquids that can enter into reactions with other liquids and/or solids is preferred. This preferably concerns neutralization reactions of the wash active ingredients.

It has been surprisingly found that on granulating solid and liquid components using a mixer/granulator with a downstream fluid bed granulator, the granule solubility as well as preferably the particle size of the granule can be adjusted by splitting up the liquid component between the mixer/granulator and fluid bed. It was determined that the solubility of the granules is still further improved if the liquid components used in the overall process are added in increasing amounts in the mixer/granulator and in lower amounts in the fluid bed. Preferably, more finely divided granules are then also obtained.

In the inventive method, the individual process steps are preferably run continuously.

In the first process step of the inventive method, well known conventional solid and liquid ingredients of detergents and/or cleansing agents are granulated in a conventional way, wherein any known mixer, granulator and/or compacting machine can be employed. For example, machines from the companies Vomm, Lödige, Schugi, Eirich, Henschel or Fukae can be employed.

The granulation can be carried out in a mixer/granulator or in several in-line coupled mixers/granulators that have optionally different mixing and granulation speeds. In a preferred embodiment of the invention, the first process step is carried out in two in-line coupled mixers/granulators. For this it is advantageous if a pre-granule is first prepared in a high-speed mixer/granulator and then the further granulation and compaction is effected in a slower running mixer/granulator, optionally with further added solid and liquid ingredients. Preferably, the residence time in the high-speed mixer is below 1 minute, in particular significantly below 1 minute, whereas the residence times in the preferred, slower, continuous granulators are preferably up to several minutes, advantageously between 1 and 10 minutes, more advantageously between 2 and 8 minutes but particularly between 3 and 5 minutes.

However, a process methodology is also particularly preferred that uses two in-line coupled mixer/granulators, wherein firstly the slower running mixer/granulator and then the high-speed mixer/granulator are employed, as for example is also described in the European Patent 0 642 576 B1.

The solid and liquid components in the first process step can be added in any order. However, the liquid components are preferably sprayed onto the solids that are already in the mixer/granulator and which are being moved around by means of the mixing tools or by rotation of the mixing drum. In the context of the present invention, the liquid components also include components that are pumpable at the respective processing temperature and in particular sprayable liquid components.

The second process step occurs in a fluid bed. Depending on the process variant, this second process step comprises a further addition of liquids and/or a post-treatment or conditioning of the product. If liquids are added, then they are coated on the fluidized granule from the first step by spraying, preferably in a finely divided form. The fluidization of the granule is carried out with air that may vary in temperature depending on the process variant and the liquid component. The liquid component can be the same component as in the first process step. However, it may also be a different component.

The types and amounts of the preferred solid and liquid ingredients that are added are given below.

The amounts of the liquid components that are added into the mixer/granulator or the fluid bed depend on the desired solubility of the granules obtained as the final product of the process.

Advantageously, the addition of liquid components into the mixer/granulator and the fluid bed granulator is split up in such a way that at least 30 wt. %, advantageously at least 40 wt. %, further advantageously at least 50 wt. %, even more advantageously at least 60 wt. %, preferably at least 70 wt. % particularly 100 wt. % of the total liquid components used in the granule production are added into the mixer/granulator. A method carried out in this way represents a preferred embodiment of the invention.

The just cited splitting up of the liquid component is therefore advantageous because in this way granules are formed that also have a high solubility in addition to good flow characteristics, wherein those granules for which a higher portion of liquid component was added into the mixer/granulator have an even better solubility than those for which a higher portion of liquid component was added into the fluid bed.

Therefore, because granules for which a higher portion of liquid component was added into the mixer/granulator during their production, particularly those for which the addition of liquid components into the mixer/granulator and the fluid bed granulator is split up in such a way that no more than 30 wt. %, advantageously no more than 20 wt. %, further advantageously no more than 15 wt. %, even more advantageously no more than 10 wt. %, preferably no more than 5 wt. % particularly 0 wt. % of the total liquid components used in the granule production are added into the fluid bed granulator during their production, are granules with particularly high solubility, a method carried out in this way represents a preferred embodiment of the invention.

In particular, if the liquid components are split up such that 0 wt. % of the liquid components added during the granule production is added to the fluid bed granulator, that is the totality of the liquid component goes into the mixer/granulator, then the resulting granules—the final product of the process—exhibit an excellent solubility. Advantageously, the resulting granules are also more finely divided than by splitting up the liquids between the mixer/granulator and fluid bed. When no liquid components are added in the fluid bed granulator, then the fluid bed only serves to post-treat/condition the products from the process.

In the inventive method, a further factor influencing the adjustment of the desired solubility of the granules was found to be the location of the nozzles in the fluid bed.

A method, in which the nozzles of the fluid bed granulator are located above the fluidized product and spray in the direction of flow of the fluid bed, is a preferred embodiment of this invention. Using this methodology, the particle size of the granule and the granule solubility can be selectively reduced in comparison with a methodology in which the nozzles spray counter to the flow direction of the fluid bed and/or inside the fluidized layer.

Thus, the method, wherein the atomization occurs counter to the flow direction of the fluid bed and/or in the fluidized product, is also a preferred embodiment.

In consequence, locations of the nozzles to produce larger granules with increased solubility are also preferred embodiments of the invention.

Naturally, solid components are also used in the production of granules. In a preferred embodiment, a particulate starting material that is preferably suitable for use in detergents and/or cleansing agents is processed in the mixer/granulator, wherein especially substances, selected from the group of the builders, polymers and/or neutral salts, are at least partially utilized.

In this context, the particulate starting material advantageously at least partially comprises solid neutralizers, preferably one or a plurality of substances from the group sodium carbonate, sodium hydroxide, sodium sesquicarbonate, potassium hydroxide and/or potassium carbonate, wherein the presence of sodium carbonate is strongly preferred, this again corresponding to a preferred embodiment of the invention. More advantageously, a neutralizer can also be added in liquid form, particularly both in solid as in liquid form.

Particularly advantageous particulate starting materials comprise solids from the group of the silicates, aluminum silicates, sulfates, citrates and/or phosphates. A further preferred embodiment of the invention concerns the use of such solids in the inventive process.

Liquid components are advantageously used that are selected from the group water, liquid binders and/or solutions of active detergent substances and/or active cleansing substances and/or dispersions, particularly suspensions and/or emulsions of active detergent substances and/or active cleansing substances. Should the inventive method be carried out with such liquid components, then this is a preferred embodiment of the invention.

According to a further preferred embodiment of the invention, the liquid component at least partially comprises anionic surfactant acid, preferably one or a plurality of substances from the group of carboxylic acids, half esters of sulfuric acid and sulfonic acids, advantageously from the group of the fatty acids, the fatty alkyl sulfuric acids and the alkylaryl sulfonic acids, particularly from the group of C₈₋₁₆-, particularly the C₉₋₁₃-alkylbenzene sulfonic acids.

In a further embodiment, the liquid component at least partially comprises non-ionic surfactants that are liquid at the processing temperature.

Here the amount of the added anionic surfactant acids is limited such that the content of neutralized anionic surfactant acids in the process product is maximum 50 wt. %, preferably 8 to 42 wt. %, particularly preferably 10 to 35 wt. % and especially 15 to 25 wt. %, which again corresponds to a preferred embodiment of the invention.

In a further embodiment, the liquid component at least partially comprises non-ionic surfactants that are liquid at the processing temperature.

In a further preferred embodiment of the invention, all ingredients comprising anionic surfactant acid, particularly all surfactant ingredients, are incorporated in the first process step, i.e. the liquid component that is added into the fluid bed is free of anionic surfactant acid, in particular totally exempt of surfactants.

Particularly preferred liquid components comprise, at least partially, silicate- and/or (co)polymer solutions, in particular aqueous solutions of sodium silicates and/or polymeric polycarboxylates. According to a preferred embodiment, all ingredients comprising silicate solutions and/or (co)polymer solutions are incorporated in the second process step.

If the mixture from the mixer/granulator and/or from the fluid bed is separated from coarse fractions and/or fines and these coarse fractions and/or fines are subsequently fed back into the mixer/granulator and/or fluid bed granulator, then this represents a preferred embodiment of the invention, particularly when the coarse fraction is milled prior to returning it to the mixer/granulator and/or the fluid bed granulator.

According to a preferred embodiment, the inventively obtained granules are blended with additional ingredients of detergents and/or cleansing agents in a pre-processing step.

Advantageously, all known ingredients of detergents and/or cleansing agents can be used in the inventive process, in particular by blending the inventively obtained granules with additional constituents of detergents and/or cleansing agents in a pre-processing step. In particular, it is preferred to use anionic and non-ionic surfactants, but also cationic surfactants, amphoteric surfactants and zwitterionic surfactants, inorganic and organic builders, bleaching agents, alkaline and neutral salts, graying inhibitors, enzymes and enzyme stabilizers and customary minor components, such as optical brighteners and colorants and fragrances, both in the inventive granule and/or as the mixable ingredients. The solid ingredients can be incorporated as powder and/or granules in the process, for example during the granulation and/or as the mixable ingredient. The solid starting materials that can be added, for example in powder form, concern for example zeolites, particularly zeolite A and/or P, sodium carbonate, tripolyphosphate, amorphous or crystalline silicates or sodium sulfate. In a further preferred embodiment of the invention, compounds comprising more than one active component can also be used as the solid ingredient. These include, for example, spray dried powder, also concentrated surfactant granules, for example those comprising 40 to 95 wt. % alkyl sulfates and/or alkylbenzene sulfonates.

It is advantageous to prepare the inventive granules with additional solid ingredients, powders, granules and solid compounds. The typical detergent ingredients and/or cleansing agent ingredients can therefore be comprised in the inventive granule or in the ingredients to be blended in the granule or in both.

Exemplary suitable anionic surfactants are those of the sulfonate and sulfate type.

Suitable surfactants of the sulfonate type are advantageously C₉₋₁₃ alkylbenzene sulfonates, olefin sulfonates, i.e. mixtures of alkene- and hydroxyalkane sulfonates, and disulfonates, as are obtained, for example, by the sulfonation with gaseous sulfur trioxide of C₁₂₋₁₈ monoolefins having a terminal or internal double bond and subsequent alkaline or acidic hydrolysis of the sulfonation products.

Those alkane sulfonates, obtained from C₁₂₋₁₈ alkanes by sulfochlorination or sulfoxidation, for example, with subsequent hydrolysis or neutralization, are also suitable.

The esters of α-sulfofatty acids (ester sulfonates), e.g. the α-sulfonated methyl esters of hydrogenated coco-, palm nut- or tallow acid are likewise suitable.

Further suitable anionic surfactants are sulfated fatty acid glycerin esters represented by mono-, di- and triesters and also their mixtures, such as those obtained by the esterification of a monoglycerin with 1 to 3 moles fatty acid or by the transesterification of triglycerides with 0.3 to 2 moles glycerin. The sulfonation products form a complex mixture comprising mono-, di- and triglyceride sulfonates with sulfonic acid groups in the α- and/or internal position. Sulfonated fatty acid salts, glyceride sulfates, glycerin sulfates, glycerin and soaps are formed as by products. On sulfonating saturated fatty acids or mixtures of hydrogenated fatty acid glycerin esters, the fraction of di-salts of α-sulfonated fatty acid can be as much as 60 wt. %, depending on the process control.

Other suitable anionic surfactants are the salts of alkylsulfosuccinic acid, which are also referred to as sulfosuccinates or esters of sulfosuccinic acid and the monoesters and/or di-esters of sulfosuccinic acid with alcohols, preferably fatty alcohols and especially ethoxylated fatty alcohols. Preferred sulfosuccinates comprise C₈-to C₁₈ fatty alcohol groups or mixtures thereof. Especially preferred sulfosuccinates comprise a fatty alcohol group derived from ethoxylated fatty alcohols and may be considered as non-ionic surfactants (see description below). Once again the especially preferred sulfosuccinates are those, whose fatty alcohol groups are derived from ethoxylated fatty alcohols with narrow range distribution. It is also possible to use alk(en)ylsuccinic acid with preferably 8 to 18 carbon atoms in the alk(en)yl chain, or salts thereof.

Preferred alk(en)yl sulfates are the alkali and especially the sodium salts of the sulfuric acid half-esters of the C₁₂-C₁₈ fatty alcohols, for example from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl group produced on a petro-chemical basis and which show similar degradation behaviour to the suitable compounds based on fat chemical raw materials. From the point of view of the detergent industry, C₁₆-C₁₈ alk(en)yl sulfates are particularly preferred. Here, it may be also of particular advantage and in particular an advantage for detergents for machine washing, to use C₁₆-C₁₈ alk(en)yl sulfates in combination with low melting anionic surfactants and particularly with such anionic surfactants that have a low Krafflt point and which show a reduced tendency to crystallize at relatively low wash temperatures of, for example, room temperature to 40° C. Thus, in a preferred embodiment of the invention, the agents comprise mixtures of short chain and long chain fatty alkyl sulfates, preferably mixtures of C₁₂-C₁₄ fatty alkyl sulfates or C₁₂-C₁₈ fatty alkyl sulfates with C₁₆-C₁₈ fatty alkyl sulfates and particularly C₁₂-C₁₆ fatty alkyl sulfates with C₁₆-C₁₈ fatty alkyl sulfates. However, in a further preferred embodiment of the invention, not only saturated alkyl sulfates are added, but also unsaturated alkenyl sulfates with an alkenyl chain length of preferably C₁₆ to C₂₂. In this context, mixtures of saturated, sulfonated, predominantly C₁₆ fatty alcohols and unsaturated, sulfonated, predominantly C₁₈ fatty alcohols are preferred, for example those that derive from mixtures of solid or liquid fatty alcohols of the type HD-Ocenol® (commercial product of the applicant). Here, the weight ratios of alkyl sulfates to alkenyl sulfates are preferably 10:1 to 1:2 and particularly about 5:1 to 1:1. Mixtures in which the alkyl groups are distributed in the proportions 15 to 40 wt. % C₁₂, 5 to 15 wt. % C₁₄, 15 to 25 wt. % C₁₆, 30 to 60 wt. % C₁₈, and less than 1 wt. % C₁₀ are preferably used.

The 2,3-alkyl sulfates, which are manufactured according to the U.S. Pat. No. 3,234,258 or 5,075,041, and which can be obtained from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, for example 2-methyl-branched C₉₋₁₁ alcohols with an average of 3.5 mole ethylene oxide (EO) or C₁₂₋₁₈ fatty alcohols with 1 to 4 EO. Due to their high foaming performance, they are only used in relatively small quantities in detergents, for example in amounts of 1 to 5% by weight.

Soaps in particular can be considered as further anionic surfactants, preferably in amounts of 0.2 to 10 wt. %. Saturated fatty acid soaps are particularly suitable, such as the salts of lauric acid, myristic acid, palmitic acid, stearic acid, hydrogenated erucic acid and behenic acid, and especially soap mixtures derived from natural fatty acids such as coconut oil fatty acid, palm kernel oil fatty acid or tallow fatty acid.

Anionic surfactants may be in the form of their sodium, potassium or ammonium salts or as soluble salts of organic bases, such as mono-, di- or triethanolamine. Preferably, the anionic surfactants are in the form of their sodium or potassium salts, especially in the form of sodium salts. Their content in the inventively manufactured granules can be preferably 3 to 20 wt. %, but can also exceed this level. Preferred anionic surfactants are fatty alkyl sulfates, alkylbenzene sulfonates, particularly in combination with soaps, as well as sulfsuccinates.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain linear and methyl-branched groups in the form of the mixtures typically present in oxoalcohol groups. Particularly preferred are, however, alcohol ethoxylates with linear groups from alcohols of natural origin with 12 to 18 carbon atoms, e.g. from coco-, palm-, tallow- or oleyl alcohol, and an average of 2 to 8 EO per mol alcohol. Exemplary preferred ethoxylated alcohols include C₁₂₋₁₄ alcohols with 3 EO or 4 EO, C₉₋₁₁ alcohols with 7 EO, C₁₃-C₁₅ alcohols with 3 EO, 5 EO, 7 EO or 8 EO, C₁₂-C₁₄-alcohols with 3 EO, C₁₈ alcohols with 3 EO, 5 EO or 7 EO and mixtures thereof, such as mixtures of C₁₂-C₁₄ alcohol with 3 EO and C₁₂-C₁₈ alcohol with 5 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO. In addition to non-ionic surfactants that are liquid at room temperature and flowable at processing temperatures, non-ionic surfactants that are still solid at the processing temperature, but are preferably plastically softened, can also be used in the inventive process. The content of non-ionic surfactants in the inventively manufactured granules is particularly 5 to 15 wt. %.

Furthermore, as additional non-ionic surfactants, alkyl glycosides that satisfy the general Formula RO(G)ₓ can be added, where R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1 and 10, preferably between 1.2 and 1.4.

Another class of preferably used non-ionic surfactants, which are used either as the sole non-ionic surfactant or in combination with other non-ionic surfactants, in particular together with alkoxylated fatty alcohols and/or alkyl glycosides, are alkoxylated, preferably ethoxylated or ethoxylated and propoxylated fatty acid alkyl esters preferably containing 1 to 4 carbon atoms in the alkyl chain, more particularly the fatty acid methyl esters that are described, for example, in the Japanese Patent application JP 58/217598 or which are preferably produced by the process described in the International Patent application WO-A-90/1 3533. C₁₂-C₁₈ fatty acid methyl esters containing an average of 3 to 15 EO, particularly containing an average of 5 to 12 EO, are particularly preferred.

Non-ionic surfactants of the amine oxide type, for example N-cocoalkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

Other suitable surfactants are polyhydroxyfatty acid amides corresponding to the Formula (I), 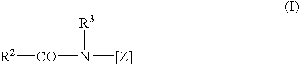
in which R²CO stands for an aliphatic acyl group with to 6 to 22 carbon atoms, R³ for hydrogen, an alkyl or hydroxyalkyl group with to 1 to 4 carbon atoms and [Z] for a linear or branched polyhydroxyalkyl group with 3 to 10 carbon atoms and 3 to 10 hydroxyl groups. The polyhydroxyfatty acid amides are advantageously derived from reducing sugars having 5 or 6 carbon atoms, especially from the glucoses.

The group of polyhydroxyfatty acid amides also includes compounds corresponding to the Formula (II), 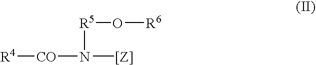
in which R⁴ is a linear or branched alkyl or alkenyl group containing 7 to 12 carbon atoms, R⁵ is a linear, branched or cyclic alkyl group or an aryl radical containing 2 to 8 carbon atoms and R⁶ is a linear, branched or cyclic alkyl group or an aryl group or an oxyalkyl group containing 1 to 8 carbon atoms, C₁-C₄ alkyl or phenyl groups being preferred, and [Z] is a linear polyhydroxyalkyl group, of which the alkyl chain is substituted by at least two hydroxy groups, or alkoxylated, preferably ethoxylated or propoxylated derivatives of that group. Z is preferably obtained by reductive amination of a sugar such as glucose, fructose, maltose, lactose, galactose, mannose or xylose. The N-alkoxy- or N-aryloxy-substituted compounds may then be converted, for example, according to the teaching of the international application WO-A-95/07331, into the required polyhydroxyfatty acid amides by the reaction with fatty acid methyl esters in the presence of an alkoxide as the catalyst

The so-called gemini surfactants can be considered as further surfactants. Generally speaking, such compounds are understood to mean compounds that have two hydrophilic groups and two hydrophobic groups per molecule. As a rule, a “spacer” separates these groups from one another. The spacer is usually a hydrocarbon chain that is intended to be long enough such that the hydrophilic groups are a sufficient distance apart to be able to act independently of one another. These types of surfactants are generally characterized by an unusually low critical micelle concentration and the ability to strongly reduce the surface tension of water. In exceptional cases, however, not only dimeric but also trimeric surfactants are meant by the term gemini surfactants.

Exemplary suitable gemini surfactants are sulfonated hydroxy mixed ethers according to the German Patent application DE-A 43 21 022 or dimer alcohol bis- and trimer alcohol tris-sulfates and -ether sulfates according to the older German Patent application P195 03 061.3. Blocked end group dimeric and trimeric mixed ethers according to the older German Patent application P195 13 391.9 are especially characterized by their bifunctionality and multifunctionality. Thus, the cited blocked end group surfactants possess good wetting properties and are therefore poor foamers, such that they are particularly suited for use in automatic washing or cleaning processes.

However, gemini polyhydroxyfatty acid amides or polyhydroxyfatty acid amides, such as those described in the international Patent applications WO-A-95/19953, WO-A-95/19954 and WO95-A419955 can also be used.

Of the suitable fine crystalline, synthetic zeolites containing bound water, zeolite A and/or P are preferred. Zeolite MAP® (a commercial product of Crosfield) and Wessalith® NaP (commercial product of Degussa) are particularly preferred as the zeolite P. However, zeolite X as well as mixtures of A, X and/or P are also suitable. The zeolite can be employed as the spray-dried powder or also as the non-dried, still moist from its manufacture, stabilized suspension. For the case where the zeolite is added as a suspension, this can comprise small amounts of non-ionic surfactants as stabilizers, for example 1 to 3 wt. %, based on the zeolite, ethoxylated C₁₂-C₁₈ fatty alcohols with 2 to 5 ethylene oxide groups, C₁₂-C₁₄ fatty alcohols with 4 to 5 ethylene oxide groups or ethoxylated isotridecanols. Suitable zeolites have a mean particle size of less than 10 μm (volume distribution, as measured by the Coulter Counter Method) and contain preferably 18 to 22% by weight and more preferably 20 to 22% by weight of bound water.

Suitable substitutes or partial substitutes for phosphates and zeolites are crystalline, layered sodium silicates corresponding to the general formula NaMSiₓO₂₊₁*yH₂O.H₂O, wherein M is sodium or hydrogen, x is a number from 1.9 to 4 and y is a number from 0 to 20, preferred values for x being 2, 3 or 4. These types of crystalline-layered silicates are described, for example, in the European Patent application EP-A-0 164 514. Preferred crystalline-layered silicates of the given formula, are those in which M stands for sodium and x assumes the values 2 or 3. Both β- and δ-sodium disilicates Na₂Si₂O₅*yH₂O are particularly preferred.

Preferred builders also include amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of this invention, the term “amorphous” also means “X-ray amorphous”. In other words, the silicates do not produce any of the sharp X-ray reflexes typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This is to be interpreted to mean that the products have microcrystalline regions between 10 and a few hundred nm in size, values of up to at most 50 nm and especially up to at most 20 nm being preferred. This type of X-ray amorphous silicates are described, for example, in the German Patent application DE-A44 00 024. Compacted/densified amorphous silicates, compounded amorphous silicates and over dried X-ray-amorphous silicates are particularly preferred. Amorphous silicates, also however excellently in aqueous form, can be used as the non-surfactant detergent and/or cleansing agent ingredient for conditioning.

Useful organic builders are, for example, the polycarboxylic acids, preferably added in the form of their sodium salts, such as citric acid, adipic acid, succinic acid, glutaric acid, tartaric acid, sugar acids, aminocarboxylic acids, nitrilotriacetic acid (NTA), providing such a use is not objected to on ecological grounds, and mixtures thereof. Preferred salts are the salts of polycarboxylic acids such as citric acid, adipic acid, succinic acid, glutaric acid, tartaric acid, sugar acids and mixtures thereof.

Further suitable organic builders are dextrins, for example oligomers or polymers of carbohydrates that can be obtained by the partial hydrolysis of starches. The hydrolysis can be carried out using typical processes, for example acidic or enzymatic catalyzed processes. This preferably concerns hydrolysis products with average molecular weights in the range 400 to 500 000. A polysaccharide with a dextrose equivalent (DE) of 0.5 to 40 and, more particularly from 2 to 30 is preferred, the DE being an accepted measure of the reducing effect of a polysaccharide in comparison with dextrose, which has a DE of 100. Both maltodextrins with a DE between 3 and 20 and dry glucose syrups with a DE between 20 and 37 and also so-called yellow dextrins and white dextrins with relatively high molecular weights of 2000 to 30 000 may be used. A preferred dextrin is described in the British Patent application 94 19 091. The oxidized derivatives of such dextrins concern their reaction products with oxidizing agents that are capable of oxidizing at least one alcohol function of the saccharide ring to the carboxylic acid function. Such oxidized dextrins and processes for their manufacture are known for example from the European Patent applications EP-A 0 232 202, EP-A 0 427 349, EP-A 0 472 042 and EP-A 0 542 496 as well as from the international Patent applications WO-A-92/18542, WO-A-93/08251, WOA-94/28030, WO-A-95/07303, WO-A-95/12619 and WO-A-95/20608. A product oxidized at C₆ of the saccharide ring can be particularly advantageous.

Suitable exemplary polymeric polycarboxylates are the sodium salts of polyacrylic or polymethacrylic acid, for example those with a relative molecular weight of 800 to 150 000 (based on the acid). Suitable (co)polymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 5000 to 200 000, preferably 10 000 to 120 000 and especially 50 000 to 100 000.

The content of (co)polymeric polycarboxylates in the granules is preferably 0.5 to 8 wt. %.

It is particularly preferred to add at least a part, preferably up to 100 wt. % of the added (co)polymeric polycarboxylates not as the solid constituent, but preferably in the form of an about 20 to 55 wt. % aqueous solution as the component of the granulation liquid.

Particular preference is also given to biodegradable polymers comprising more than two different monomer units, examples being those comprising, as monomers, salts of acrylic acid and of maleic acid, and also vinyl alcohol or vinyl alcohol derivatives, as in DE-A 43 00 772, or those comprising, as monomers, salts of acrylic acid and of 2-alkylallylsulfonic acid, and also sugar derivatives as in DE-C-42 21 381.

Further preferred copolymers are those that are described in the German Patent applications DE-A 43 03 320 and DE-A 44 17 734 and that preferably have acrolein and acrylic acid/acrylic acid salts or acrolein and vinyl acetate as monomers.

The (co)polymeric polycarboxylates can either be added as powder or as an aqueous solution, wherein they can be used particularly in aqueous form as the non-surfactant detergent and/or cleansing agent ingredient for conditioning.

Further suitable builders are oxidation products of polyglucosans that contain carboxylic groups, and/or their water-soluble salts, such as, for example, as described in the international Patent application WO-A-93/08251 or whose manufacture is described in the international Patent application WO-A-93/161 10.

Further suitable cobuilders are oxydisuccinates and other derivatives of disuccinates, preferably ethylenediamine disuccinate. In this context, glycerine disuccinates and glycerine trisuccinates are also particularly preferred, such as those described in the US Patents U.S. Pat. No. 4,524,009, U.S. Pat. No. 4,639,325, in the European Patent application EP-A 0 150 930 and in the Japanese Patent application JP 93/339896. Suitable addition quantities in zeolite-containing and/or silicate-containing formulations range from 3 to 15% by weight.

Other useful organic co-builders are, for example, acetylated hydroxycarboxylic acids and salts thereof which optionally may also be present in lactone form and which contain at least 4 carbon atoms, at least one hydroxyl group and at most two acid groups. Such cobuilders are described, for example, in the international Patent application WO-A-95/20029.

Similarly, other preferred builders are polymeric aminodicarboxylic acids, salts or precursors thereof. Those polyaspartic acids or their salts and derivatives disclosed in the German Patent application DE-A 195 40 086.0 as having a bleach-stabilizing action in addition to cobuilder properties are particularly preferred.

Further suitable builders are polyacetals that can be obtained by treating dialdehydes with polyol carboxylic acids that possess 5 to 7 carbon atoms and at least 3 hydroxyl groups, as described in the European Patent application EP-A-0 280 223. Preferred polyacetals are obtained from dialdehydes like glyoxal, glutaraldehyde, terephthalaldehyde as well as their mixtures and from polycarboxylic acids like gluconic acid and/or glucoheptonic acid.

In addition, the agents can also comprise components that positively influence the oil and fat removal from textiles during the wash. This effect is particularly noticeable when a textile is dirty and had been previously already washed several times with an inventive detergent that comprised this oil- or fat-removing component. The preferred oil and fat removing components include, for example, non-ionic cellulose ethers such as methyl cellulose and methyl hydroxypropyl cellulose with a content of methoxy groups of 15 to 30 wt. % and hydroxypropoxy groups of 1 to 15 wt. %, each based on the non-ionic cellulose ether, as well as polymers of phthalic acid and/or terephthalic acid or their derivatives known from the prior art, particularly polymers of ethylene terephthalates and/or polyethylene glycol terephthalates or anionically and/or non-ionically modified derivatives thereof.

Further suitable ingredients of the agent are water-soluble inorganic salts such as bicarbonates, carbonates, the already cited amorphous silicates or mixtures of these; alkali carbonate and amorphous silicate are particularly used. The sodium carbonate content in the agent is preferably up to 20 wt. %, advantageously between 5 and 15 wt. %.

Among the compounds, which serve as bleach agents and liberate H₂O₂ in water, sodium perborate tetrahydrate and sodium perborate monohydrate are of particular importance. Examples of further bleaching agents that may be employed are sodium percarbonate, peroxypyrophosphates, citrate perhydrates and H₂O₂-liberating peracidic salts or peracids, such as perbenzoates, peroxyphthalates, diperoxyazelaic acid, phthaloimino peracid or diperoxydodecanedioic acid. The bleach agent content of the agent is preferably 5 to 25 wt. % and particularly 10 to 20 wt. %, perborate monohydrate or percarbonate being advantageously used.

The preparations can comprise bleach activators in order to achieve an improved bleaching action for washing temperatures of 60° C. and below. Examples of these are N-acyl- or O-acyl compounds forming organic peracids with H₂O₂, preferably N,N′-tetraacylated diamines, p-(alkanoyloxy) benzene sulfonates, in addition caprolactam derivatives, carboxylic acid anhydrides and esters of polyols like glucose pentaacetate. Additionally known bleach activators are acetylated mixtures of sorbitol and mannitol, as are described, for example, in the European Patent application EP-A-0 525 239. The bleach activator content of the agent containing the bleach agent is in the typical range, preferably between 1 and 10 wt. % and particularly between 3 and 8 wt. %. Particularly preferred bleach activators are N,N, N′,N′-tetraacetylethylenediamine (TAED), 1,5-diacetyl-2,4-dioxo-hexahydro-1,3,5-triazine (DADHT) and acetylated sorbitol-mannitol mixtures (SORMAN).

When used in automatic washing processes, it can be advantageous to add conventional foam inhibitors to the agents. Suitable foam inhibitors include for example, soaps of natural or synthetic origin, which have a high content of C₁₈-C₂₄ fatty acids. Suitable non-surface-active types of foam inhibitors are, for example, organopolysiloxanes and mixtures thereof with microfine, optionally silanized silica and also paraffins, waxes, microcrystalline waxes and mixtures thereof with silanized silica or bis-stearyl ethylenediamide. Mixtures of various foam inhibitors, for example mixtures of silicones, paraffins or waxes, are also used with advantage. Preferably, the foam inhibitors, especially silicone-containing and/or paraffin-containing foam inhibitors, are loaded onto a granular, water-soluble or dispersible carrier material. Especially in this case, mixtures of paraffins and bis stearylethylene diamides are preferred.

The neutral reacting sodium salts of, for example, 1-hydroxyethane-1,1-diphosphonate, diethylenetriaminepentamethylene phosphonate or ethylenediamintetramethylene phosphonate are used as the polyphosphonic acid salts in amounts of 0.1 to 1.5 wt. %.

Suitable enzymes are, in particular, those from the classes of hydrolases, such as proteases, lipases or lipolytic enzymes, amylases, cellulases or mixtures thereof. Oxireductases are also suitable.

Enzymatic active materials obtained from bacterial sources or fungi such as bacillus subtilis, bacillus licheniformis, streptomyceus griseus und humicola insolens are particularly well suited. Proteases of the subtilisin type and particularly proteases that are obtained from bacillus lentus, are preferably used. Here, mixtures of enzymes are of particular interest, for example proteases and amylases or proteases and lipases or lipolytic enzymes or proteases and cellulases or cellulases and lipase or lipolytic enzymes or proteases, amylases and lipases or lipolytic enzymes or proteases, lipases or lipolytic enzymes and cellulases, in particular, however protease-containing and/or lipase-containing mixtures or mixtures with lipolytic enzymes Examples of such lipolytic enzymes are the known cutinases. Peroxidases or oxidases have also proved to be suitable in certain cases. The suitable amylases particularly include α-amylases, iso-amylases, pullulanases and pectinases. Cellobiohydrolases, endoglucanases and β-glucosidases or mixtures thereof, which are also known as cellobiases are preferred cellulases. As the different cellulase types differ in their CMCase and avicelase activities, the required activities can be adjusted by controlled mixtures of the cellulases.

The enzymes can be adsorbed on carriers and/or embedded in cladding substances, in order to protect them against premature decomposition. The content of the enzymes, enzyme mixtures or enzyme granules may be, for example, about 0.1 to 5% by weight and is preferably 0.1 to about 2% by weight.

Graying inhibitors have the function of maintaining the dirt that was removed from the fibers suspended in the washing liquor, thereby preventing the dirt from resettling. Water-soluble colloids of mostly organic nature are suitable for this, for example the water-soluble salts of polymeric carboxylic acids, glue, gelatins, salts of ether carboxylic acids or ether sulfonic acids of starches or celluloses, or salts of acidic sulfuric acid esters of celluloses or starches. Water-soluble, acid group-containing polyamides are also suitable for this purpose. Moreover, soluble starch preparations and others can be used as the abovementioned starch products, e.g. degraded starches, aldehyde starches etc. Polyvinyl pyrrolidone can also be used. Preference, however, is given to the use of cellulose ethers such as carboxymethyl cellulose (Na salt), methyl cellulose, hydroxyalkyl celluloses, and mixed ethers such as methyl hydroxyethyl cellulose, methyl hydroxypropyl cellulose, methyl carboxymethyl cellulose and mixtures thereof, as well as polyvinyl pyrrolidone, which can be added, for example in amounts of 0.1 to 5 wt. %, based on the agent.

The agents may comprise derivatives of diaminostilbene disulfonic acid or alkali metal salts thereof as the optical brighteners. Suitable optical brighteners are, for example, salts of 4,4′-bis-(2-anilino-4-morpholino-1,3,5-triazinyl-6-amino)stilbene-2,2′-disulfonic acid or compounds of similar structure which contain a diethanolamino group, a methylamino group, an anilino group or a 2-methoxyethylamino group instead of the morpholino group. Brighteners of the substituted diphenylstyryl type may also be present, for example the alkali metal salts of 4,4′-bis(2-sulfostyryl)diphenyl, 4,4′-bis(4-chloro-3-sulfostyryl)diphenyl or 4-(4-chlorostyryl)-4′-(2-sulfostyryl)diphenyl. Mixtures of the mentioned brighteners may also be used.

A further subject matter of the invention is a process for manufacturing detergent- and/or cleansing agent granules comprising the steps

a) blending and granulating one or a plurality of solid components with one or a plurality of liquid components in one or a plurality of mixers/granulators

b) transferring the granules resulting from a) into a fluidized bed and spraying one or a plurality of liquid components onto the fluid bed formed in the fluidized bed and further granulation,

wherein the components to be sprayed in the fluidized bed do not comprise any anionic surfactant acid, are in particular free of surfactant and preferably at least partially possess film-forming ingredients.

Film-forming ingredient is understood to mean all surfactant-free materials or mixtures that are capable of forming films on substrate surfaces, e.g. by the fact that they are first dissolved in a solvent (water, ethanol or others), deposited or sprayed onto the substrate and after evaporation of the solvent, form films. The film forming components can also, for example, be applied or sprayed in a molten liquid state onto the substrate, such that these components on solidifying form a film on the substrate. In general, particularly preferred film-forming components are silicates and/or solutions of (co)polymers. Acrylic acid (co)polymers, cellulose derivatives, vinyl pyrrolidone-vinyl acetate copolymers with different monomer proportions, polymers based on vinyl pyrrolidone-vinyl acetate and vinyl propionate, polyethylene oxide resins, polyvinyl acetate, polyvinyl alcohol and protein hydrolyzates are further preferred. Film-formers based on natural resins are e.g. decolorized shellac, sandarac gum, benzoic resins and colophonium.

Advantageously, these process variants result in granules that are indeed soluble, but less soluble than the previously mentioned granules, because in the fluidized bed, an anionic, surfactant-free, particularly surfactant-free component is formed round the granule, which during use has to dissolve before the granule core that comprises surfactant can itself dissolve. A further differentiation of the solubility behaviour of the granule is thereby successful in regard to a controlled release of the active materials, for example.

A preferred embodiment of the invention is when the liquid component of process step a) is selected from the group of liquid binders, solutions of active detergent substances and/or active cleansing substances and/or dispersions, preferably suspensions and/or emulsions of active detergent substances and/or active cleansing substances, wherein the liquid component advantageously at least partially comprises anionic surfactant acid, very advantageously one or a plurality of substances from the group of the carboxylic acids, the half esters of sulfuric acid and the sulfonic acids, particularly advantageously from the group of the fatty acids, the fatty alkyl sulfuric acids and the alkylaryl sulfonic acids, in particular from the group of the C₈₋₁₆, particularly the C₉₋₁₃ alkylbenzene sulfonic acids.

A preferred embodiment of the invention is when the solid components are suitable for use in detergents and/or cleansing agents and preferably, substances selected from the group of the builders, polymers and/or neutral salts are at least partially utilized, wherein advantageously, solid neutralizers, very advantageously one or a plurality of substances from the group of sodium carbonate, sodium hydroxide, sodium sesquicarbonate, potassium hydroxide and/or potassium carbonate are at least partially comprised.

A preferred embodiment of the invention is when the solid components comprise solids from the group of the silicates, aluminum silicates, sulfates, citrates and/or phosphates.

Another preferred embodiment of the invention is when the liquid component of process step b), which comprises no anionic surfactant acid and in particular is exempt of surfactant, is selected from the group of liquid binders and/or the aqueous solution or aqueous dispersion of one or a plurality of detergent and/or cleansing agent ingredients that are not surfactants, such as preferably amorphous silicates, carbonates, sulfates, and/or organic salts such as phosphonates, polycarboxylates, particularly citrate, and/or polymeric polycarboxylates, wherein particularly silicate solutions and/or (co)polymer solutions are particularly preferred.

It is also preferred to mix the granules of the abovementioned type with additional ingredients to form a detergent and/or cleansing agent.

A further subject matter of the invention is a preferably particulate detergent and/or cleansing agent that comprises inventive granules from one of the inventive processes. In a preferred embodiment, the detergent and/or cleansing agent comprises a plurality of granules from a plurality of process variants, i.e. with different solubility characteristics.

In order to obtain the desired composition of the preferably particulate detergent and/or cleansing agent, the premix of the particulate detergent and/or cleansing agent advantageously comprises the inventive granule further supplemented with customary preparative components as well as preferably an additional or further mixable granules.

The addition of these mixable granules is advantageous, particularly to incorporate additional amounts of anionic surfactants and/or particularly (co)polymer(s) and/or water glass into the detergent and/or cleansing agent.

The additional mixable granule thus comprises those ingredients, which are totally absent in the first inventive granule, and/or preferably also more of those ingredients that were already comprised in the first inventive granule, but whose content in the total composition of the overall detergent and/or cleansing agent can or must be increased. Besides the customary carrier substances, such as preferably sulfate, soda, tripolyphosphate or zeolites, they particularly concern anionic surfactants and (co)polymers. The additional mixable granule can be manufactured by any conventional method known to the person skilled in the art.

Depending on the process variant in the production of the inventive granule, the combination of both granules affords particulate detergents and/or cleansing agents that for the same material composition in regard to the total particulate detergent and/or cleansing agent, nevertheless have different properties, for example, their respective solubilities. Advantageously, these properties are essentially affected by the properties of the inventive granules comprised in the detergent and/or cleansing agent.

According to a preferred embodiment, the detergents and/or cleansing agents comprise, besides the inventive granules, further particulate detergent- and/or cleansing agent ingredients, in particular mixable granules containing anionic surfactant and/or water glass/(co)polymer, which particularly concern spray drying products, wherein the polymer is for example polyacrylic acid and its sodium salts or polyacrylates or the copolymers are those of acrylic acid with maleic acid.

According to another preferred embodiment, the mixable granule concerns further granule(s) produced according to one of the inventive processes, wherein preferably, only aqueous solutions of components from the detergents and cleansing agents are used as the liquid components in the production of this mixable granule, wherein particularly silicate solutions and/or (co)polymer solutions are particularly preferred.

According to a further preferred embodiment, the detergents and/or cleansing agents comprise at least 30 wt. %, preferably at least 40 wt. %, advantageously at least 50 wt. %, particularly at least 60 wt. % of the inventive granules (without mixable granules).

As has been determined, the solubility of the granules worsens especially when increasing liquid fractions are processed during the granulation, in particular when anionic surfactants are employed as the granulation liquid or in particular when the granulation liquid comprises anionic surfactants or their precursors.

For manufacturing detergents and/or cleaning agents that are advantageously very highly soluble and fine, besides the conventional preparative components known to the person skilled in the art, an inventive granule is blended with an additional mixable granule that comprises the remainder of the desired components and is preferably produced by spray drying. For the production of the inventive granule, the liquid components are advantageously added solely in the mixer/granulator. The granule is post treated in the fluidized bed. Advantageously the comprised anionic surfactant is split up between the inventive granule and the second granule, such that preferably not more than 70 wt. % of the total anionic surfactants comprised in the detergent and/or cleansing agent are incorporated through the inventive granule and preferably not less than 30 wt. % through the second granule. The second granule in this case preferably comprises silicate and (co)polymer fractions.

The particle size d₅₀ of the inventive granule is advantageously 0.3 to 0.4 mm. Preferably, the particle size d₅₀ of the resulting particulate detergent and/or cleansing agent is then 0.4 to 0.6 mm. Very highly soluble detergents and/or cleansing agents dissolve almost completely within 90 seconds in 30° C. warm water with residues of preferably 1-1.5 wt. %. In particular, the added granules are completely dissolved in the process.

For manufacturing detergents and/or cleaning agents that are highly soluble, at least one inventive granule as well as an additional mixable granule that comprises further components and is preferably produced by spray drying are added besides the conventional preparative components. For the production of the inventive granules, in this case the liquid components are advantageously added solely in the mixer/granulator. The granule is post treated in the fluidized bed. In contrast to the previously described product, the anionic surfactant fractions of the finished detergent and/or cleansing agent are totally comprised in the inventive granule. The total amounts of the silicate and (co)polymer are preferably completely comprised in the mixable granule. Both the inventive granule and also the resulting finished detergent and/or cleansing agent preferably have a particle size d₅₀ of 0.8 to 1.0 mm. Highly soluble detergents and/or cleansing agents dissolve almost completely within 90 seconds in 30° C. warm water with residues of preferably 1.5-2.0 wt. %. The added inventive granules are preferably dissolved with residues of 1 wt. %.

For manufacturing detergents and/or cleaning agents that are still highly soluble, but are coarser, at least one inventive granule as well as an additional mixable granule that comprises further components and is preferably produced by spray drying are added besides the conventional preparative components. In contrast to the previously described product, the addition of the liquid component is split up between the mixer/granulator and the fluidized bed, preferably in such a way that the liquid component is split up in the proportion of circa 3:1 between the mixer/granulator and the fluidized bed. In this case, preferably all anionic surfactant ingredients comprised in the total detergent and/or cleansing agent are incorporated into the detergent and/or cleansing agent through the inventive granule. The silicate and (co)polymer fractions are preferably completely comprised in the mixable granule.

In this case, the particle size d₅₀ of the inventive granule and the detergent and/or cleansing agent is preferably 1.3 to 1.6 mm. These highly soluble, coarse detergents and/or cleansing agents dissolve within 90 seconds in 30° C. warm water with residues of preferably 2.5-3.0 wt. %. The added granules are preferably dissolved with residues of ca. 2 wt. %.

Granules with delayed dissolution are granules that initially scarcely go into solution, but then, preferably after dissolution of an external sheath, go efficiently and speedily into solution like the previously described granules. In the most preferred case, the sheath layer consists of silicates and/or (co)polymers. Preferably, the granule contains the anionic surfactants in the core. These kinds of granules are very advantageous for use in a detergent tablet and surprisingly lead to a rapid disintegration and high solubility of the tablet.

Granules with delayed dissolution can preferably be prepared by spraying the total anionic surfactant fraction in the mixer/granulator and spraying aqueous silicate solution and (co)polymer solution in the fluidized bed. Additional amounts of (co)polymer and silicate are preferably mixed with the detergent and cleansing agent using an additional mixable granule produced by spray drying. In the production of this mixable granule, it is also advantageous, for example, if preferably ca. 66% of the aqueous liquids are sprayed onto e.g. soda and sulfate in the mixer/granulate and preferably the remaining 34% are sprayed in the fluidized bed. The granule with delayed dissolution has an average particle size d₅₀ of preferably 1.3 to 1.5 mm, the solubility in 30° C. warm water is preferably delayed such that after 5 minutes, residues of preferably 5 to 6 wt. % can still be observed. The second mixable granule has an average particle size d₅₀ of preferably 1.0 mm and is preferably dissolved without any residue after 90 seconds.

These granules with delayed dissolution are of great interest, particularly for detergent tablets that will be discussed further below.

The fine dispersion and the solubility of the granule are preferably collectively dependent on the total fractions of the liquid incorporated in the granule. Coarse granules, for which a higher liquid fraction was used for the granulation, are generally less soluble than fine granules, for which lower liquid fractions were added for the granulation. As the liquid fractions added for the granulation are preferably active substances of the detergent and cleansing agent, the use of lesser amounts of liquid fractions for the inventive granules requires that the missing active substances in the prepared detergent and/or cleansing agent that comprises the inventive granule be supplemented by an additional component that comprises the missing fraction of active substances. This is preferably the previously mentioned second granule or mixable granule that is especially a spray-dried product.

It was surprisingly found that preferably fine detergent- and/or cleansing agent blends that comprise, besides a fine inventive granule, granulated with only a part of the total liquid components required for the detergent and/or cleansing agent, an additional mixable granule produced with the remaining liquids, are significantly more highly soluble than detergent- and/or cleansing agent blends that comprise granules, granulated with higher amounts, preferably all of the liquid components, particularly anionic surfactant components, required for the detergent and/or cleansing agent.

Accordingly, such detergents and/or cleansing agents are a preferred embodiment of the invention. The second mixable granule component can be manufactured by a conventional granulation process or also by an inventive process, but preferably by spray drying.

A further subject matter of the invention is a detergent tablet and/or cleansing agent tablet, comprising inventive granules from one of the inventive processes, in particular an inventive process, for which the components to be sprayed in the fluidized bed do not comprise anionic surfactant acids, are especially exempt of any surfactant and preferably, at least partially, possess film forming ingredients, and/or comprising an inventive detergent and/or cleansing agent. Preferably, the tablets comprise at least 20 wt. %, advantageously at least 30 wt. %, more advantageously at least 40 wt. %, even more advantageously at least 50 wt. %, particularly at least 60 wt. % of the corresponding inventive granules, based on the total weight of the tablet.

It was surprisingly found that even the granule, whose preparation involved components to be sprayed in the fluidized bed, which do not comprise anionic surfactant acids, are especially exempt of any surfactant and preferably at least partially possess film-forming ingredients to delay dissolution, makes possible a very good tablet disintegration, if the tablet comprises a typical disintegrant in addition to this granule.

Without being bound by this or any other theory, this seemingly paradoxical fact is explained by assuming that the addition of the granule with delayed dissolution results in a delayed dissolution of the individual particles by gel formation of the surfactant with water and therefore in the first instance the disintegrant disintegrates the tablet into individual granules. The granules can subsequently dissolve. Thus, the tablet disintegrates within a few seconds.

In contrast, tablets that include comparatively faster dissolving granules do not already disintegrate after a few seconds, but first after some minutes or not at all.

According to a preferred embodiment of the invention, the tablet comprises at least one swellable disintegration auxiliary. All common disintegrants are preferred in equal measure.

A tablet that comprises a swellable disintegration aid based on cellulose, preferably in granular, cogranulated or compacted form, in quantities of 0.5 to 10 wt. %, preferably 1 to 8 wt. % and particularly 2 to 7 wt. %, each based on the tablet weight, is a preferred embodiment of the invention.

A preferred embodiment of the invention is when the tablet is at least partially encased in a water-soluble sheath, wherein this comprises one or more materials from the group (optionally acetalized) polyvinyl alcohol (PVAL) and/or PVAL copolymers, polyvinyl pyrrolidone, polyethylene oxide, polyethylene glycol, gelatin, cellulose and derivatives thereof, particularly MC, HEC, HPC, HPMC and/or CMC, and/or copolymers as well as mixtures thereof.

A further subject matter of the invention is the use of the previously described tablets in household washing machines or household dishwashers and likewise in the use as dispensing draw dosable detergent tablets for household washing machines.

### EXAMPLES

Four examples are described below, which afforded four particulate universal detergents with essentially the same composition (in wt. %) in regard to the total composition, into which, however, different inventive granules were incorporated. The different granules produced universal detergents with different properties.

Composition of the Universal Detergent (Hereafter Named UD):

| | | |
|---|---|---|
| A. Granular components: | 70 | wt. % |
| consisting of: | | |

| | | |
|---|---|---|
| Surfactants | 11-16 | wt. % |
| Phosphonate | 0.5-1 | wt. % |
| Soda and Na hydrogen carbonate | 17-22 | wt. % |
| Silicate | 2-5 | wt. % |
| Sodium polyacrylate | 2-4 | wt. % |
| Na - sulfate/water/salts | made up to 70 | wt. % |

| | | |
|---|---|---|
| B. Common preparative components | 30 | wt. % |
| Graying inhibitor | 0.5-1 | wt. % |
| Foam inhibitor | 2-4 | wt. % |
| Optical brightener | 0.1-0.3 | wt. % |
| Enzymes | 0.5-1 | wt. % |
| Bleach/bleach activator | 15-20 | wt. % |
| Fragrance | 0.1-0.5 | wt. % |
| Surfactants | 0-2 | wt. % |
| Soda/Na hydrogen carbonate/Na sulfate | made up to 30 | wt. % |

### Example 1

Production of Inventive Granule A:

In a continuous free-falling mixer (drum with baffles), 35.5 wt. % sodium sulfate and 46.3 wt. % soda were sprayed with 18.5 wt. % of an acid mixture that was itself composed of 75.3 wt. % alkylbenzene sulfonic acid, 11.2 wt. % fatty acid, 10.5 wt. % Turpinal®SL-solution (60% aqueous) and 3 wt. % water.

(Turpinal®SL is Hydroxyethane-1,1-Diphosphonic Acid; Ex Solutia Inc.)

The post treatment of the mixture was carried out in a continuous fluidized bed with 40° C. warm air and a residence time of 10 minutes.

The product was sieved through a 1.25 mm sieve. The residual fraction of 20 wt. % was again transferred to the mixer/granulator after milling. Fines were not separated.

After neutralization, the composition of the granule A was as follows:

| Parts granule A: | 100.00 wt. % |
|---|---|
| LAS | 14.27 wt. % |
| Soap | 2.22 wt. % |
| Na₄HEDP | 1.64 wt. % |
| Sodium hydrogen carbonate | 3.42 wt. % |
| Sodium sulfate | 35.78 wt. % |
| Sodium carbonate | 40.59 wt. % |
| Water/salts | 2.08 wt. % |

(LAS = alkylbenzene sulfonate; Na₄HEDP = tetra sodium salt of hydroxyethylene diphosphonic acid)

To make the finished product (the universal detergent), granule A was blended with spray-dried mixable granule Z having the following composition:

| Parts mixable granule Z: | 100.00 wt. % |
|---|---|
| LAS | 20.00 wt. % |
| Silicate | 13.20 wt. % |
| Sokalan PA 30 | 12.00 wt. % |
| Sodium sulfate | 50.00 wt. % |
| Water | 4.80 wt. % |

(Sokalan PA 30 = sodium polyacrylate 45 wt. % in H₂O ex BASF)

The granulates were blended up in the proportions given below to a universal detergent I (hereafter called UD I) and yielded the universal detergent with the following properties:

UD I consisted of:

| | |
|---|---|
| granule A | 47 wt. % |
| mixable granule Z | 23 wt. % |
| Common preparative components | 30 wt. % |

### Properties of Example 1

| | | |
|---|---|---|
| | granule A | universal detergent I |
| bulk density | 645 g/l | 524 g/l |

Particle distribution (sieve analysis)

| | | | |
|---|---|---|---|
| <0.1 | mm | 2 wt. % | 1 wt. % |
| 0.10-0.20 | mm | 15 wt. % | 11 wt. % |
| 0.20-0.40 | mm | 37 wt. % | 31 wt. % |
| 0.40-0.63 | mm | 23 wt. % | 28 wt. % |
| 0.63-0.80 | mm | 9 wt. % | 16 wt. % |
| 0.80-1.25 | mm | 14 wt. % | 13 wt. % |

solubility *

| | | | |
|---|---|---|---|
| L-Test 90 | sec. | 0.1 wt. % | 1.5 wt. % |
| L-Test 300 | sec. | 0 wt. % | 0.9 wt. % |

The L-Test 90 sec. produced a value of 0 wt. % for the mixable granule Z.
* The residue behavior and the solubility behavior of granule A, the mixable granule and the universal detergent I was determined using the L-Test and the L300-Test.

L-Test:

The residue behavior and the solubility behavior were determined by dispersing 8 g of the test material in a 2 l beaker by stirring (800 rpm with laboratory stirrer/propeller-stirring head centered 1.5 cm from the bottom of the flask) for 90 seconds at 30° C. The experiment was carried out with water of a hardness of 16° d. The suds were then poured through a sieve (80 μm). The beaker was rinsed out over the sieve with very little cold water. The experiment was repeated. The sieves were dried at 40° C.±2° C. to constant weight in a drying oven and the detergent residue was weighed. The residue is expressed as the average value of the two experiments in wt. %. For variations in the individual results of more than 20%, then usually additional tests are carried out; however, this was not necessary for the present experiments.

L300-Test: This corresponds to the L-Test with the difference that stirring at 30° C. is not 90, but 300 seconds.

### Example 2

Production of Granule B:

In a continuous free-falling mixer (drum with baffles), 42.8 wt. % sodium sulfate and 33.5 wt. % soda were sprayed with 24.53 wt. % of an acid mixture that was itself composed of 82.4 wt. % alkylbenzene sulfonic acid, 6.9 wt. % fatty acid, 6.7 wt. % Turpinal®SL-solution (60% aqueous) and 4 wt. % water.

The post treatment of the mixture was carried out in a continuous fluidized bed with 40° C. warm air and a residence time of 10 minutes.

The product was sieved through a 2.0 mm sieve. The residual fraction of ca. 15 wt. % was again transferred to the mixer/granulator after milling. Fines were not separated.

After neutralization, the composition of the granule B was as follows:

| Parts of granule B | 100.00 wt. % |
|---|---|
| LAS | 21 wt. % |
| Soap | 1.84 wt. % |
| Na₄HEDP | 1.36 wt. % |
| Sodium sulfate | 42.84 wt. % |
| Sodium hydrogen carbonate | 4.15 wt. % |
| Sodium carbonate | 26.14 wt. % |
| Water/salts | 2.67 wt. % |

To make the finished product (the universal detergent), granule B was blended with spray-dried mixable granule ZZ having the following composition:

| Parts mixable granule ZZ: | 100.00 wt. % |
|---|---|
| sodium sulfate | 17.47 wt. % |
| Sodium carbonate | 27.07 wt. % |
| Sokalan PA 30 | 20.00 wt. % |
| Silicate | 22.00 wt. % |
| water | 13.46 wt. % |

As a result of blending the granules in the proportions given below to form a universal detergent II (hereafter called UD II), the following properties were obtained:

UD II consisted of:

| | |
|---|---|
| granule B | 53.8 wt. % |
| mixable granule ZZ | 16.2 wt. % |
| Common preparative components | 30 wt. % |

### Properties of Example 2

| | | |
|---|---|---|
| | granule B | universal detergent II |
| bulk density | 615 g/l | 560 g/l |

Particle distribution (sieve analysis)

| | | | | | |
|---|---|---|---|---|---|
| 0.1 | mm | 0.4 | wt. % | 1.5 | wt. % |
| 0.1-0.2 | mm | 1.3 | wt. % | 3.4 | wt. % |
| 0.2-0.4 | mm | 5.2 | wt. % | 8.5 | wt. % |
| 0.4-0.8 | mm | 17.4 | wt. % | 34.8 | wt. % |
| 0.8-1.25 | mm | 25.2 | wt. % | 22.3 | wt. % |
| 1.25-1.60 | mm | 35.2 | wt. % | 21.4 | wt. % |
| 1.60-2.00 | mm | 15.3 | wt. % | 8.1 | wt. % |

solubility *

| | | | | | |
|---|---|---|---|---|---|
| L-Test 90 | sec. | 1.2 | wt. % | 2.2 | wt. % |
| L-Test 300 | sec. | 0.5 | wt. % | 1.5 | wt. % |

The L-Test 90 sec. produced a value of 0 wt. % for the mixable granule ZZ.
* for methods for determining the solubility, see example 1.

### Example 3

Production of Granule C:

In a continuous free-falling mixer (drum with baffles), 44.2 wt. % sodium sulfate and 32.7 wt. % soda were sprayed with 18.0 wt. % of an acid mixture that was itself composed of 82.4 wt. % alkylbenzene sulfonic acid, 6.9 wt. % fatty acid, 6.7 wt. % Turpinal®SL-solution (60% aqueous) and 4 wt. % water.

In addition, 6 wt. % of the same acidic mixture was additionally sprayed in the fluidized bed held at ca. 40° C. The residence time in the fluidized bed was ca. 10 minutes. The product was sieved through 2.0 mm and 0.8 mm sieves.

After milling, the residual fraction of ca. 15 wt. % and the ca. 25% fines that were smaller than 0.8 mm were again transferred to the mixer/granulator.

After neutralization, the composition of the granule C was as follows:

| Parts granule C | 100.00 wt. % |
|---|---|
| LAS | 20.49 wt. % |
| Soap | 1.79 wt. % |
| Na₄HEDP | 1.33 wt. % |
| Sodium sulfate | 44.22 wt. % |
| Sodium hydrogen carbonate | 4.05 wt. % |
| Sodium carbonate | 25.51 wt. % |
| Water/salts | 1.93 wt. % |

To make the finished product (the universal detergent), granule C was blended with spray-dried mixable granule ZZ having the following composition:

| Parts mixable granule ZZ | 100.00 wt. % |
|---|---|
| Sodium sulfate | 17.47 wt. % |
| Sodium carbonate | 27.07 wt. % |
| Sokalan PA 30 | 20.00 wt. % |
| Silicate | 22.00 wt. % |
| Water | 13.46 wt. % |

As a result of blending the granules in the proportions given below to form a universal detergent III (hereafter called UD III), the following properties were obtained:

UD III consisted of:

| | |
|---|---|
| granule C | 55 wt. % |
| mixable granule ZZ | 15 wt. % |
| remainder according to the listed composition | 30 wt. % |

### Properties of Example 3

| | | |
|---|---|---|
| | granule C | Universal detergent III |
| bulk density | 595 g/l | 524 g/l |

Particle distribution (sieve analysis)

| | | | | | |
|---|---|---|---|---|---|
| <0.1 | mm | 0 | wt. % | 1 | wt. % |
| 0.1-0.2 | mm | 0 | wt. % | 2 | wt. % |
| 0.2-0.4 | mm | 0 | wt. % | 4 | wt. % |
| 0.4-0.8 | mm | 5 | wt. % | 7 | wt. % |
| 0.8-1.25 | mm | 15 | wt. % | 18 | wt. % |
| 0.8-1.60 | mm | 47 | wt. % | 42 | wt. % |
| 1.60-2.00 | mm | 33 | wt. % | 26 | wt. % |

solubility *

| | | | | | |
|---|---|---|---|---|---|
| L-Test 90 | sec. | 2.0 | wt. % | 2.8 | wt. % |
| L-Test 300 | sec. | 0.5 | wt. % | 1.5 | wt. % |

The L-Test 90 sec. produced a value of 0 wt. % for the mixable granule ZZ.
* for methods for determining the solubility, see example 1.

### Example 4

Production of Granule D:

In a continuous free-falling mixer (drum with baffles), 36.39 wt. % sodium sulfate and 31.11 wt. % soda were sprayed with 22.77 wt. % of an acid mixture that was itself composed of 82.6 wt. % alkylbenzene sulfonic acid, 6.94 wt. % fatty acid, 6.74 wt. % Turpinal®SL-solution (60% cn.) and 4 wt. % water.

17.18 wt. % of a liquid mixture consisting of 44.7 wt. % of a 45 wt. % Sokalan PA 30 solution and 55.3 wt. % of a water glass solution (modulus 2.0) was sprayed onto the fluidized granule in the fluidized bed downstream from the mixer/granulator.

The product was dried with hot air at 110° C. in the fluidized bed to ca. 5-6 wt. % residual water.

The product was sieved through 2.0 mm and 0.8 mm sieves.

After milling, the residual fraction of ca. 15 wt. % and the ca. 25% fines that were smaller than 0.8 mm were again transferred to the mixer/granulator.

After neutralization, the composition of the granule D was as follows:

| Parts granule D | 100.00 wt. % |
|---|---|
| LAS | 19.45 wt. % |
| Soap | 1.70 wt. % |
| Na₄HEDP | 1.26 wt. % |
| Sodium sulfate | 36.31 wt. % |
| Sodium hydrogen carbonate | 3.84 wt. % |
| Sodium carbonate | 24.20 wt. % |
| Sokalan PA 30 | 3.45 wt. % |
| Silicate | 3.79 wt. % |
| Water/salts | 5.36 wt. % |

The universal detergent of this example comprises, in addition to the granule D and the usual preparative components, a further mixable granule E.

The composition of the mixable granule E was as follows:

| Parts mixable granule E | 100.00 wt. % |
|---|---|
| Sodium sulfate | 35.54 wt. % |
| Sodium carbonate | 33.87 wt. % |
| Sokalan PA 30 | 8.11 wt. % |
| Silicate | 8.92 wt. % |
| Water | 13.56 wt. % |

As a result of blending the granules in the proportions given below to form a universal detergent IV (hereafter called UD IV), the following properties were obtained:

UD IV consisted of:

UD IV consisted of:

| | |
|---|---|
| granule D | 58 wt. % |
| mixable granule E | 12 wt. % |
| remainder according to the listed composition | 30 wt. % |

### Properties of Example 4

| | | | |
|---|---|---|---|
| | | Mixable | universal |
| | granule D | granule E | detergent IV |
| bulk density | 675 g/l | 560 g/l | 665 g/l |

Particle distribution (sieve analysis)

| | | | | | | | |
|---|---|---|---|---|---|---|---|
| <0.1 | mm | 0 | wt. % | 0 | wt. % | 1.0 | wt. % |
| 0.1-0.2 | mm | 0 | wt. % | 0 | wt. % | 2.0 | wt. % |
| 0.2-0.4 | mm | 0 | wt. % | 0 | wt. % | 4.0 | wt. % |
| 0.4-0.8 | mm | 5.0 | wt. % | 6.0 | wt. % | 7.0 | wt. % |
| 0.8-1.25 | mm | 25.0 | wt. % | 48.0 | wt. % | 25.0 | wt. % |
| 1.25-1.6% | | 52.0 | wt. % | 35.0 | wt. % | 47.0 | wt. % |
| 1.6-2.0 | mm | 18.0 | wt. % | 11.0 | wt. % | 14.0 | wt. % |

solubility*

| | | | | | | | |
|---|---|---|---|---|---|---|---|
| L-Test 90 | sec. | 7.3 | wt. % | 0 | wt. % | 4.9 | wt. % |
| L-Test 300 | sec. | 0.2 | wt. % | 0 | wt. % | 1.5 | wt. % |

*for methods for determining the solubility, see example 1.

Particle Distribution (Sieve Analysis)

### Conclusions from Examples 1-4

The universal detergents listed in the examples comprised, besides the usual preparative components, the described granules and in each case an additional mixable granule, in which further active substances in liquid form had been incorporated. The production variants of the granule in the mixer/granulator and fluidized bed and the split up of the incorporated liquids A and B in the granule manufactured according to the claimed process as well as in an additional mixable granule influenced the properties of the universal detergent.

The liquid component A was LAS-H (alkylbenzene sulfonic acid) that reacted during the granulation to LAS-Na (sodium alkylbenzene sulfonate).

The liquid component B was a mixture of 40 wt. % water glass solution (modulus 2.0) and 45 wt. % Sokalan PA 30 solution.

Comparison of the Process Variants:

Data as active substance contents in the universal detergent from the granule and mixable granule.

| | 1. Granule ** | | | | | | | |
|---|---|---|---|---|---|---|---|---|
| | Mixer/granulator | | Fluid bed | | Mixable granule | | UD | |
| | Liquid component | | Liquid component | | Liquid component | | Liquid component | |
| | LAS- Na | B | LAS- Na | B | LAS- Na | B | LAS- Na | B |
| | wt. % | wt. % | wt. % | wt. % | wt. % | wt. % | wt. % | wt. % |
| UD I | 6.7 | 0 | 0 | 0 | 4.6 | 6.3 | 11.3 | 5.8 |
| UD II | 11.3 | 0 | 0 | 0 | 0 | 6.8 | 11.3 | 6.8 |
| UD III | 7.5 | 0 | 3.8 | 0 | 0 | 6.3 | 11.3 | 6.3 |
| UD IV | 11.3 | 0 | 0 | 4.2 | 0 | 2.04 | 11.43 | 6.24 |

** 1. granule is based on the universal detergent: UD I comprises granule A, UD II comprises granule B, UD III comprises granule C, UD IV comprises granule D

Comparison of the Product Properties:

| | bulk density | bulk density | L-Test | L-Test | L300-Test | L300-Test |
|---|---|---|---|---|---|---|
| | Granule | UD | Granule | UD | Granule | UD |
| | [g/L] | [g/L] | [wt. %] | [wt. %] | [wt. %] | [wt. %] |
| UD I - Granule A | 645 | 524 | 0.1 | 1.5 | 0 | 0.9 |
| UD II - Granule B | 615 | 560 | 1.2 | 2.2 | 0.5 | 1.5 |
| UD III - Granule C | 595 | 524 | 2.0 | 2.8 | 0.5 | 1.5 |
| UD IV - Granule D | 675 | 665 | 7.3 | 4.9 | 0.2 | 1.5 |
| Mixable granule E | 560 | 665 | 0 | | 0 | |
| in UD IV | | | | | | |

### CONCLUSIONS

The supplemented mixable granules had an L-Test of 0. Therefore other mixable components and particularly the 1. granule, produced by the claimed process, had a direct influence on the dissolution behavior of the thus-prepared universal detergent.
The solubility of the universal detergent can be directly correlated with the solubility of the included inventive granules. Thus, very highly soluble universal detergents were obtained when the added 1. Granules, manufactured according to the claimed process, are very highly soluble.
The solubility of the granules manufactured according to the claimed process was graded as follows:
   Very highly soluble, fine granules were obtained when the liquid component A was only partially added in the granulation and thereby only in the mixer/granulator, and no liquid component was added in the fluidized bed. The complete fraction of the liquid component B and the remaining fraction of the liquid component A were added during the production in the supplementary mixable granules comprised in the UD (see UD I/granule A)
   Highly soluble, somewhat coarser granules were obtained when the liquid component A was completely added in the granulation and thereby only in the mixer/granulator, and no liquid component was added in the fluidized bed. The complete fraction of the liquid component B and none of the liquid component A were added during the production in the supplementary mixable granules comprised in the UD (see UD II/granule B)
   Acceptably soluble, coarser granules were obtained when the liquid component A was completely added in the granulation and was thereby used both in the mixer/granulator as well as in the fluidized bed. The liquid component was therefore split up between the mixer/granulator and the fluidized bed. The complete fraction of the liquid component B and none of the liquid component A were added during the production in the supplementary mixable granules comprised in the UD (see UD III/granule C)
   Coarse granules with delayed dissolution were obtained when the liquid component A was completely added in the granulation and thereby only in the mixer/granulator, and a part of the liquid component B was added in the fluidized bed. The liquid components were therefore split up between the mixer/granulator and the fluidized bed, the surfactant-free and film-forming components being added in the fluidized bed. The remaining fractions of the liquid component B were added during the production in the supplementary mixable granule that was comprised in the UD (see UD IV/granule D).

### Example 5

In accordance with the European Patent application EP 0 970 181 B1, 37.2 g of each of the detergents UD I-UD IV, manufactured in examples 1-4, were compacted with 2.8 g of a tablet disintegrator based on cellulose into 40 g tablets with a fracture toughness of 40 N. 5 tablets were produced of each.

The tablet disintegration was determined by dipping the tablet into water at 20° C. by means of a device such that all sides came into contact with water. The tablets comprising UD I, the tablets comprising UD II and the tablets comprising UD III first disintegrated after 5-6 minutes in the agent.

The tablets comprising UD IV already disintegrated after 7 seconds in the agent.

This is a surprising result as UD IV had the worst solubility.

On compacting the tablets to a fracture toughness of 60N, the tablets comprising UD I or UD II or UD III no longer disintegrated. Corresponding tablets with UD IV disintegrated already after 17 seconds in the agent.

This surprising result demonstrates the excellent suitability of UD IV and the granule D incorporated therein for the manufacture of detergent and/or cleansing agent tablets that still exhibit a very good disintegration even at high fracture toughnesses.

The inventive tablets that comprise the UD IV therefore disintegrate exceptionally rapidly even in cold water and much faster than the tablets comprising UD I or UD II or UD III. This is all the more surprising as the UD IV comprises the granules with the worst solubility.

1-37. (canceled)

38. A process comprising:
(a) blending a solid component and a liquid component in a mixer/granulator to form an intermediate granule mix; and
(b) further treating the intermediate granule mix in a fluidized bed granulator to form granules;
wherein a first portion of the liquid component is introduced into the mixer/granulator and a second portion of the liquid component is introduced into the fluidized bed granulator.

39. The process according to claim 38, wherein the first portion of the liquid component comprises at least 30% by weight of the total liquid component.

40. The process according to claim 38, wherein the first portion of the liquid component comprises at least 70% by weight of the total liquid component.

41. The process according to claim 38, wherein the second portion of the liquid component comprises up to 30% by weight of the total liquid component.

42. The process according to claim 38, wherein the second portion of the liquid component comprises up to 5% by weight of the total liquid component.

43. The process according to claim 38, wherein the solid component comprises a particulate starting material selected from the group consisting of builders, polymers, neutral salts, and mixtures thereof.

44. The process according to claim 38, wherein the solid component comprises a neutralizer selected from the group consisting of sodium carbonate, sodium hydroxide, sodium sesquicarbonate, potassium hydroxide, potassium carbonate, and mixtures thereof.

45. The process according to claim 38, wherein the liquid component comprises an ingredient selected from the group consisting of water, liquid binders, solutions, dispersions, suspensions and emulsions of active detergent/cleansing substances, and mixtures thereof.

46. The process according to claim 45, wherein all solutions, dispersions, suspensions and emulsions of active detergent/cleansing substances are present in the first portion of the liquid component.

47. The process according to claim 38, wherein the liquid component comprises an ingredient selected from the group consisting of anionic surfactant acids, non-ionic surfactants, and mixtures thereof.

48. The process according to claim 47, wherein all anionic surfactant acids are present in the first portion of the liquid component.

49. The process according to claim 38, wherein the liquid component comprises a solution selected from the group consisting of silicate solutions, polymer solutions, and mixtures thereof.

50. The process according to claim 49, wherein the solution is present in the second portion of the liquid component.

51. The process according to claim 38, wherein the granules have a maximum neutralized anionic surfactant acid content of up to 50% by weight.

52. The process according to claim 38, further comprising separating coarse and/or fine fraction from a process stream and re-introducing at least a portion of the separated fraction back into the process.

53. The process according to claim 52, wherein the separated fraction is milled prior to reintroducing the separated fraction back into the process.

54. A process comprising:
(a) blending and granulating a solid component with a first liquid component in a mixers/granulator to form an intermediate granule mix; and
(b) transferring the intermediate granule mix into a fluidized bed granulator and spraying a second liquid component onto a fluid bed formed in the fluidized bed granulator and subjecting the fluid bed to further granulation; wherein the second liquid component does not comprise any anionic surfactant acid.

55. The process according to claim 54, wherein the second liquid component does not comprise any surfactant.

56. The process according to claim 54, wherein the second liquid component comprises a film-forming ingredient.

57. The process according to claim 54, wherein the spraying is carried out counter to a direction of flow of the fluid bed.

58. The process according to claim 54, wherein one or more nozzles of the fluid bed granulator are located above the fluid bed and spraying is carried out in a direction of flow of the fluid bed.

59. A detergent/cleansing agent comprising granules prepared by the process according to claim 38.

60. A detergent/cleansing agent comprising granules prepared by the process according to claim 54.

61. The agent according to claim 59, further comprising a particulate selected from the group consisting of anionic surfactant granules, water glass/(co)polymer granules and mixtures thereof.

62. The agent according to claim 59, wherein the liquid component comprises an aqueous silicate solution.

63. A detergent/cleansing tablet comprising an agent according to claim 59.
